(19) United States
(12) Patent Application Publication
(10) Pub. No.: US 2022/0383344 A1
(43) Pub. Date: Dec. 1, 2022

(54) GENERATING NUMERICAL DATA ESTIMATES FROM DETERMINED CORRELATIONS BETWEEN TEXT AND NUMERICAL DATA

(71) Applicant: Black Swan Data Ltd., London (GB)

(72) Inventors: David Grant Soderberg, London (GB); Markus Ralph Michael Frise, London (GB); Alex Sliz-Nagy, London (GB); Soma Bálint Nagy, London (GB); Burint Bevis, London (GB); Norbert Kovacs, London (GB)

(21) Appl. No.: 17/773,539

(22) PCT Filed: Nov. 2, 2020
(86) PCT No.: PCT/GB2020/052777

§ 371 Date: Apr. 29, 2022

(30) Foreign Application Priority Data
Oct. 31, 2019 (GB) 1915879.9
Jul. 13, 2020 (GB) 2010779.3

(51) Int. Cl. G06Q 30/02

(52) U.S. Cl. CPC G06Q 30/0202

(57) ABSTRACT

The present invention relates to a method and apparatus for determining correlations between text or text-derived data and numerical data. Specifically the present invention relates to determining correlation(s) between text-derived and numerical data in order to generate estimated numerical data using the determined correlation(s) for specific text-derived data. Aspects and/or embodiments seek to provide a method for estimating numerical data using historical numerical data and historical text-derived data. Aspects and/or embodiments also seek to determine a correlation between the historical numerical data and historical text-derived data for use in generating the estimated numerical data using text-derived data, optionally to identify relevant trends in text-derived data that can be used to generate estimated/predicted numerical data, and optionally in order to train a computer implemented model to generate estimates of numerical data for given text-derived data.

### FIELD

The present invention relates to a method and apparatus for determining correlations between text or text-derived data and numerical data. Specifically, the present invention relates to determining correlation(s) between text-derived and numerical data in order to generate estimated numerical data using the determined correlation(s) for specific text-derived data.

### BACKGROUND

In order to expand into new markets or categories, it can be helpful for businesses to have an understanding of the future sales that might be expected, especially in relation to new products, markets or territories. Predictions for future sales can provide the basis for an estimate of the profitability of new or different products, changes or additions to existing products, or in the potential choice of markets and/or territories, and hence a useful tool when making decisions about expanding a business. In particular, there are associated underlying technical challenges involved such as: specifying or choosing/designing parameters of a (new) product or making sourcing decisions, including choice of particular ingredients or product components, which must be sourced at scale to meet a consumer demand that will only mature many months in the future; and optimising production resources to match the anticipated demand, including installing increased production capacity or re-purposing existing production lines to meet the expected production demand in advance of this being needed.

Accurate predictions would potentially confer many advantages, including but not limited to: the ability to capture early influencer market share, preferential access to product ingredients, extra time to mature supplier relationships and supply chain economics, substantially optimising the production capacity and configuration, and the ability to meet consumer demand when it peaks. Using such predictions, business cases can be developed to allow decisions to be made within a business, technical plans can be developed and/or optimised, and machinery capacity, configuration and usage planning can be predicted. Different business cases can then be compared to allow a business to choose the best business cases for expanding the business, and allow a business to configure and optimise any or all of its plant, machinery, software, advertising, sales and purchasing.

Conventional approaches to predicting future sales rely on historical sales data to act as a predictor for future sales. This baseline assumption works reasonably well when predicting changes in sales for existing products. However, there are two areas where conventional approaches struggle today.

The first is in the prediction of new products. As conventional approaches rely on trendlines in historical sales to predict, they struggle to predict new product sales which do not have historical sales with which to predict from.

The second is in the prediction of new product features, such as specific ingredients (e.g. Turmeric) or Benefit or Theme claims (e.g. Good for Heart Health, or Sustainable) or components (e.g. 5G vs 4G modems; or certain component sizes such as memory capacity or screen size). This second challenge is due to the sparsity of meta data about each product that is contained in most sales data sources, such as those from Nielsen or IRI. Without the appropriate metadata, it is not possible to perform the more conventional analysis.

Further, predicting new product sales that have a more specific property, such as an ingredient/component/specification or benefit, compounds both of these challenges—historical sales data does not exist, and sufficient meta data is not available in the existing sales data sources.

Conventional “marketing mix modelling” is a statistical analysis approach that can be used to estimate the impact of marketing. Marketing mix modelling comprises one or more data analytics techniques such as multivariate regressions to analyse the effect of a particular marketing strategy on sales of a product. The impact of future marketing can be predicted based on that analysis.

Demand forecasting is another tool that can be used to estimate future sales, wherein historical data from past sales is used to forecast sales in a new environment and/or under a different set of parameters.

A typical analysis for a business to undertake before a new territory is explored can comprise a past analysis of one or more territories. For example, a business selling a particular product can analyse the sales of that product in the US, Europe, and China. In this example, the analysis includes other factors which are relevant to the sales of that product, for example ambient weather conditions. Based on this analysis, a prediction may be forecast for each of those territories regarding future sales.

A correlation between the known past sales in existing market(s) and one or more other factors can also established. The correlation found may then be used to form a prediction of sales in a new market. For example, the relative size of the existing markets in which sales are made can be used to estimate the potential sales in new markets, and the correlations with factors that have been observed in existing markets can be used to refine the prediction of sales in new markets.

An example of a conventional approach to estimating predicted sales for a new market is shown in FIG. 1, which will now be described in more detail to illustrate the example. In this example, the market for which sales data for a product is to be predicted is Mexico. The existing markets in which the product is sold is in the US, Europe and China. Data on sales in the US 100 includes actual sales data over time 102 as well as a prediction of future sales 104 for sales in the US in future. Data on sales in Europe 105 includes actual sales data over time 107 as well as a prediction of future sales 109 for sales in Europe in future. Data on sales in China 110 includes actual sales data over time 111 as well as a prediction of future sales 113 for sales in China in future. The data can be combined 115 to estimate 120 the sales in Mexico 122. Typically, the predicted number of sales can be estimated by comparing the size of the market for the product in question in the US, Europe and China and the likely size of the market in Mexico over time. Further the predicted number of sales can be modelled on the experience selling the product in any one or a combination of the existing markets of the US, Europe and China—so perhaps the market in Mexico may be deemed to be most similar to that of the US but modified slightly based on experience with how the product sales grew and shrank in Europe and China.

In summary, conventional approaches for predicting future sales data are performed using some data analysis approaches, but typically with a large degree of human judgement and experience being used to generate predictions. The resulting prediction of future sales data may as a result be extremely inaccurate and open to human error and problems with the predictions stemming from human bias. As a result, many underlying technical challenges remain unsolved and solutions remain substantially inaccurate.

### SUMMARY OF INVENTION

Aspects and/or embodiments seek to provide a method for estimating numerical data using historical numerical data and historical text-derived data. Aspects and/or embodiments also seek to determine a correlation between the historical numerical data and historical text-derived data for use in generating the estimated numerical data using text-derived data, optionally to identify relevant trends in text-derived data that can be used to generate estimated/predicted numerical data, and optionally in order to train a computer implemented model to generate estimates of numerical data for given text-derived data.

In particular, aspects and/or embodiments can manipulate online text and numeric data from categorically different sources—for example free-form online consumer conversations (as online text data or text-derived data) and traditional sales data (as numerical data)—in a novel combination in order to determine a correlation between these data and generate estimates of numerical data for given text-derived data, which can then be applied to predict for example future sales of products not yet invented (i.e. numerical data), but for which there will be consumer demand, from current online consumer conversations (i.e. text derived data). Aspects and/or embodiments of the method(s) and system(s) to make this feasible in terms of scale, accuracy and efficiency comprise several technical innovations in applied machine learning, optionally including human-in-the-loop training data creation.

According to a first aspect, there is provided a computer-implemented method of generating a third set of numerical data using a second set of numerical data and a first and a second set of text derived data, comprising the following steps: receiving the second set of numerical data, the second set of numerical data comprising numerical data in a second time period; receiving the first set of text derived data, wherein the first set of text derived data comprises derived data from text data in the first time period and one or more labels; determining numerical values of the labels in the first set of text derived data; determining a correlation between the second set of numerical data and the first set of text derived data using the determined numerical values of the labels in the first set of text derived data; receiving the second set of text derived data, wherein the second set of text derived data comprises derived data from text data in the second time period and one or more labels; determining numerical values of the labels in the second set of text derived data; using the second set of text derived data, the determined numerical values of the labels in the second set of text derived data and the determined correlation between the second set of sales data and the first set of text derived data to generate the third set of numerical data wherein the third set of numerical data comprises generated numerical data in the third time period; and generating an output based at least in part on the third set of numerical data.

Using historical sales data alone only provides limited foresight in predicting future sales. Typically, historical sales data are strongly tied to previous or current market conditions and do not anticipate nor consider the general direction in which particular products or services are developing or changing. Using text derived data gathered from online text (such as social media text data) can provide information on trends among consumers and potential consumers of a product. Combining both numerical data such as historical sales data and derived text data such as identified trends in online text data can allow a correlation to be determined between these two data sets using determined numerical values for one or more labels in the text-derive data, which correlation can then be used to estimate numerical data such as sales data on a combination of the two data types. This can provide a method that can predict sales for new products or services, or in new territories, for which there is no previous sales data, through using the determined correlation between numerical data (i.e. historical sales data) and text-derived data (i.e. online text data and changes in the trends identified in the online text data over time).

For example, if an emerging trend identified in online text data has not seen significant sales during or after the trend is identified, that trend is unlikely to predict significant growth in future sales. Conversely, if an emerging trend is identified in online text data which has significant sales after the trend is identified, that trend is likely to predict significant growth in future sales. Changes in trends that strongly correlate to sales, for example where a trend becomes less popular over time after the initial interest fades, can be used to modify the prediction for corresponding sales as the correlation that has been generated may indicate that the sales will similarly fade over time.

Further, combining this aspect with the aspect related the data curation can provide a curated dataset that can be used to generate estimated or predicted numerical data from text-derived data for which a correlation has been determined.

Generating the third set of numerical data from the second set of text derived data can be performed using a random forest model which has learned the relationship between the text and numerical data from earlier time period(s).

The output of the process can be a prediction of numerical data in a specific time window or sequence of time windows into the future.

Optionally, the second set of numerical data comprises quantitative data based on historical numerical data.

A quantitative dataset can provide numerical and statistical information about the sales performance of a product or service and can itself provide an indication of the market conditions over time. Such data can be matched and correlated with other data in order to derive connections and correlations.

Optionally, the first and second set of numerical data further comprises any or any combination of: sale time and date information, sale location information; product details, unique product codes, unique product types, product description, ingredients data, product branding information, product sub-branding information, product category; pricing data, volume data, unit sales, theme information, average distribution information and average price data.

Knowing certain characteristics of the products or services that are reflected in the sales data can allow for more or more robust correlations to be determined with other data.

Optionally, a step of curating the first and second set of numerical data wherein the first and second set of numerical data is generated from a combination of quantitative data based on historical numerical data and additional product information data.

Although the numerical data can primarily provide historical sales data, the dataset can be supplemented to include additional information related to the product or service in order to enrich the historical data.

Optionally, the additional product information data is obtained by extracting relevant product information data from one or more data sources. Optionally, the first and second set of numerical data comprises any or any combination of augmented product category information; detailed ingredient information; product benefits information; processes; production processes; tasting notes; and product theme information.

Additional product information can be found by accessing a number of retail websites or online catalogues to ascertain detailed product or service descriptions from which key data can be extracted.

Optionally, a step of filtering the first and second set of numerical data to retain only predetermined data.

By performing a filtering step, extraneous detail can be removed from the data so that predetermined or known key data is retained, for example the branding details, but other data, such as for example the exact dimensions of the packaging, can be removed.

Optionally, the labels of the first set of text derived data comprise one or more trends and/or themes. Optionally, the one of more trends and/or themes include any or any combination of: brand; sub-brand; product type; ingredients; benefits and themes.

The use of identified or identifiable trends in online text data can allow for the use of behavioural or conversational trends to be associated with certain products or services (even those that are not yet sold to consumers). Having a dataset that identifies trends can enable correlation with actual sales, products or services and thus better prediction accuracy for future estimates of the sales of products or services, or even certain brands or products containing certain ingredients or that have certain properties. This online text trend dataset can be based on a period of time, for example detailing the number of times that a term or phrase is mentioned in online text posts over time.

Benefits can be represented as text extracts, or other descriptor or identifier, which text extracts can correspond to a categorised theme or benefit topics (e.g. a benefit, or “claim”, might be “improved heart health” so any text alluding to this, such as “this helps my heart” or “good for coronary health” is identified and the product can be tagged as containing or being relevant to the benefit).

Online text data and numerical (e.g. sales) data can be correlated using trends found in the metadata of the online text data (e.g. mentions of the term “Eco-Friendly” and sales of “Eco-Friendly” products). A correlation model can be built at the lowest level (i.e. at single trend term), but results can be also aggregated across a number of trend terms that might be relevant to a certain product or service.

Optionally, the first set of text derived data is generated from a plurality of online text data, optionally wherein the plurality of online text data comprises social media data.

The text data can be derived from a number of data sources that are generally described using the term “online text”, including for example: conversations from message boards like Reddit®, blog posts, product reviews, news articles, or social media platforms such as Twitter®, VK® (in Russia) and Weibo® (in China). A number of different possible modalities of data can be used, for example short or long form text data; audio data such as podcasts; or video data.

The data that is derived from the raw online text data can be a volume of times a topic, phrase, or word is mentioned in a post. The raw online text data can be processed to be substantially relevant to one or more categories and one or more trends, such as “Lemonade” being identified as a drink versus the title of a music album.

Optionally, the first set of text derived data further comprises any or any combination of: an online conversation volume; an online conversation growth; an online conversation split by data source and trend prediction value.

The online text dataset can include aggregated online conversation volume (for example across one or more social media platforms, news articles, blog posts, online forum posts and review articles), aggregated social media network “mention volume”, or aggregated online conversation volume.

The trend prediction value can be determined from a process involving the steps of (a) tagging each post as relevant to one or more trends (b) determining whether the tagged post is relevant to each of the one or more trends; and (c) filtering out the irrelevant tagged posts to determine a number of posts over time that are deemed relevant to each trend. The trend prediction value can be a calculated value that is a single metric combining measures of volume, growth and forecast—being a single metric can enable its use for ranking purposes, in particular when ranking trends by the propensity to change/grow.

Optionally, the method further comprises a step of matching the first and second set of numerical data and the first set of text derived data.

In order for the two datasets to be used together and effectively, a matching process for matching terms from the sources together can be implemented. In some instances, this may need to be continually updated as new trends are frequently added to the dataset.

Optionally, the step of matching comprises identifying common data between the second set of numerical data and the first set of text derived data.

Matching can also include a continually updated taxonomy to tag the common data such as terms found in the detailed descriptions in the ingredients, product types, themes, brand names, etc.

For example, text in the manufacturer's description of a product, or in the product ingredients list (or other sales data/augmented sales data), can be matched with trends identified in online text data—such as the ingredients list for a product mentioning that the product contains “monk fruit” and matching this term with posts and trends in the online text data so that a count of online text posts can be made for “monk fruit”.

Optionally, determining the correlation between the second set of numerical data and the first set of text derived data comprises determining one or more common labels and/or metadata in each of the second set of numerical data and the first set of text derived data; and determining the correlation between the one or more common labels and/or metadata.

In this way, a correlation can be determined by analysing the descriptors, labels and/or metadata of the two datasets.

Optionally, the one or more common descriptors (and/or metadata and/or labels) comprise any or any combination of: one or more taxonomy categories; brand, product type, ingredients, and claims.

Once the metadata/labels/descriptors have been extracted and matched to online text data, the data can be aggregated by distinct trends held in a taxonomy, for example, brands (including sub brands), product type, ingredients, benefits or themes. This can also enable modelling of the estimations at product category level, for example: candy, cookies & graham crackers, crackers, dips, dried fruit, meat jerky, nuts & seeds, other grain snacks, other wholesome snacks, salty snacks, snack bars, sweet pastry snacks, trail mix, etc. Additionally, aggregation can be accomplished at varying taxonomy levels.

Optionally, determining the correlation between the second set of numerical data and the first set of text derived data comprises determining a learned relationship between the second set of numerical data and the first set of text derived data. Optionally, the learned relationship comprises using any or any combination of: one or more random forest models or methods; hyper parameter optimisation; rolling window techniques, optionally with a holdout test set; and test window techniques. Post-processing can then be performed, which combines predictions made over different time windows to provide a more stable, smoothed prediction for output.

Optionally, the step of determining the correlation between the second set of numerical data and the first set of text derived data comprises determining one or more trends in the text derived data and then determining a relationship between each of the one or more trends to one or more products in the second set of numerical data.

Determining a relationship between the numerical (e.g. sales) data and the online text data can require a complex model to be developed between a number of common features of the datasets. As a result, the complex model can use approaches such as neural networks, machine learning and/or statistical techniques that are trained (on potentially large amounts of data) to determine correlation between the datasets.

The learned relationship can be derived from, for example, multiple random forest models trained using these two datasets.

Trends can be determined in the online text derived data using the tags applied to the dataset, for example using the tags for ingredients, benefits, etc. The online text derived data can be augmented with externally sourced data, for example data from other data sources, to enable richer tagging of the dataset. The online text derived data can be filtered for irrelevant tags, in order to clean for irrelevant content. The counts of posts, i.e. volume, can be aggregated by trend so that modelling can be carried out using the aggregated volume data for each trend determined in the tags applied to the online text data.

Optionally, the method further comprises a step of testing the correlation determined between the second set of numerical data and the first set of text derived data, the step of testing comprising: receiving a third set of text derived data, wherein the third set of text derived data comprises derived data from text data in the third time period; using the third set of text derived data and the determined correlation between the second set of numerical data and the first set of text derived data, generating the testing set of numerical data wherein the testing set of numerical data comprises generated numerical data in a fourth time period; receiving a fourth set of numerical data, the fourth set of numerical data comprising numerical data in the fourth time period; determining an accuracy metric of the determined correlation, the step of determining an accuracy metric comprising comparing the testing set of numerical data with the fourth set of numerical data; and generating an output based at least in part on the accuracy metric. Optionally, the method further comprises the step of determining an improved correlation; the step of determining an improved correlation comprising determining a correlation of any two of: (a) the second set of numerical data and the first set of text derived data; (b) the fourth set of numerical data and the third set of text derived data; (c) the testing set of numerical data and the third set of text derived data; (d) the testing set of numerical data and the fourth set of numerical data; (e) the determined accuracy metric. Optionally, the validation of the generated numerical data is performed using received numerical data for the relevant time period.

Testing the correlation that has been created between the online text data and the numerical (e.g. sales) data can allow for unreliable correlations to be identified before they are used to predict future numerical data, or can allow for correlations to be refined before they are used to predict future numerical data.

Accuracy metrics can include median absolute percentage error for numerical predictions and/or mean absolute percentage error for brand and/or product count predictions.

According to a further aspect there is provided a computer-implemented method of generating a third set of numerical data using a pre-determined correlation between numerical data and text derived data, comprising the following steps: receiving a second set of text derived data, wherein the second set of text derived data comprises derived data from text data in a second time period and one or more labels; determining numerical values of the labels in the second set of text derived data; using the second set of text derived data, the determined numerical values of the labels in the second set of text derived data and the pre-determined correlation between numerical data and text derived data to generate the third set of numerical data wherein the third set of numerical data comprises generated numerical data in a third time period; and generating an output based at least in part on the third set of numerical data. Optionally, the numerical data comprises sales data.

Optionally, the output generated comprises any or any combination of: instructions to increase, decrease or repurpose production facilities or capacity; configuration data for production machinery; usage plans for one or more plant or machinery; instructions to increase orders of raw materials or other supplies; instructions to place increased or decreased advertising, optionally sending said instructions directly to one or more advertising servers; instructions to amend or amendments to stock availability data or forecast data, optionally sending these to one or more purchaser servers; instructions to amend or amendments to raw materials or components ordering data or ordering forecast data, optionally sending these to one or more supplier servers.

Based on the output, many further technical operations can be performed manually or automatically in some aspects and/or embodiments.

Optionally, the text-derived data is curated and/or cleaned to remove irrelevant data, optionally wherein the process of curation or cleaning is performed by one of more human users.

By performing data curation, the data used can be improved to remove irrelevant data that might decrease the accuracy of any outputs.

According to a further aspect there is provided a method of data curation, for curating and/or cleaning text-derived data to isolate the text-derived data relating to one or more topics of interest, comprising: receiving text-derived data and information indicating one or more topics of interest; determining a set of vector representations of the text-derived data in a first set of dimensions, wherein each dimension represents one topic; determining a second set of vector representations of the text-derived data in a second reduced set of dimensions using a first dimension reduction algorithm; determining a third set of vector representations of the text-derived data in two dimensions using a second dimension reduction algorithm; grouping similar data in the third set of vector representations using a density-based clustering algorithm to produce an output set of data; displaying the output set of data to a user for curation, wherein displaying the output set of data comprising displaying the output set of data using a two-dimensional graphical user interface. Optionally, determining a set of vector representations of the text-derived data in a first set of dimensions comprises using global vectors for word representation algorithm and wherein the first set of dimensions comprises substantially one thousand dimensions. Optionally, the first dimension reduction algorithm comprises a principal component analysis algorithm; and the second reduced set of dimensions comprises substantially twenty five dimensions; and the second dimension reduction algorithm comprises a t-distributed stochastic neighbour embedding algorithm. Optionally, the density-based clustering algorithm comprises DBSCAN. Optionally, displaying the output set of data to a user for curation comprises using a TF-IDF algorithm. Optionally, in addition there is performed the step of receiving user input to perform any of: deleting one or more data from the text-derived data; and/or tagging, labelling or applying metadata to the text-derived data using the graphical user interface.

By performing data curation, the data used can be improved to remove irrelevant data that might decrease the accuracy of any outputs.

According to another aspect, there is provided a method of determining a trend prediction value comprising the steps of: determining one of more topics of interest; receiving text-derived data and determining a plurality of topics within the text-derived data, wherein the plurality of topics comprise the one or more topics of interest and other topics; determining a plurality of numerical values for the number of times each of the plurality of topics are mentioned in the text-derived data; determining a relative value of the numerical values of the one or more topics of interest versus the numerical values of the other topics in the text-derived data; and outputting the relative value. Optionally, the numerical values are determined for a pre-determined time period, optionally wherein the pre-determined time period is adjusted by user input or comprises a 24-month period of time. Optionally, outputting the relative value further comprises determining a trend value and outputting the trend value; optionally wherein the trend value comprises any or any combination of: dormant; emerging; growing; mature; declining; or fading.

Determining a trend prediction value can be used to determine how relevant a trend identified or that is of interest is relative to other data. Further, this aspect can be used in conjunction with other aspects to improve the determination of correlations and/or determine predictions/estimates of numerical data.

### BRIEF DESCRIPTION OF DRAWINGS

Embodiments will now be described, by way of example only and with reference to the accompanying drawings having like-reference numerals, in which:

FIG. 1 shows a conventional sales prediction analysis;

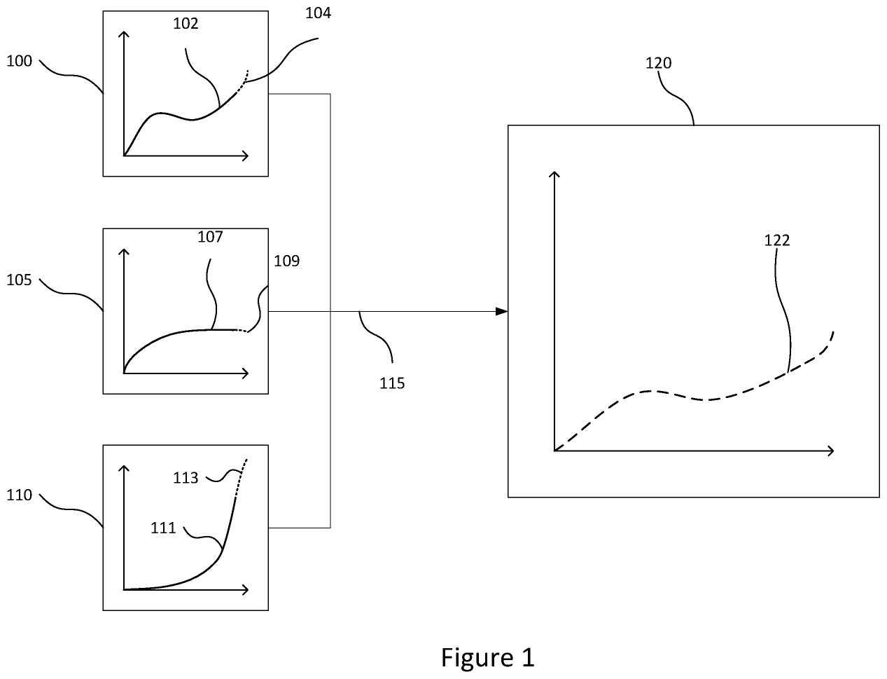

FIG. 2 shows a flow chart for sales prediction analysis based on multiple sets of online text data that outputs a sales prediction based on a determined correlation according to an embodiment;

FIG. 3 shows a sales prediction output representation that has been output from the process outlined in FIG. 2 according to an embodiment;

FIG. 4 shows a method of enriching online text data for input into the process shown in FIG. 2 according to an embodiment;

FIG. 5 shows a method of enriching sales data for input into the process shown in FIG. 2 according to an embodiment;

FIG. 6 shows the creation of a model for sales prediction analysis based on multiple sets of online text data according to an embodiment; and

FIG. 7 shows a testing procedure for the model for sales prediction analysis based on multiple sets of online text data for use with the process shown in FIG. 2 according to an embodiment.

### SPECIFIC DESCRIPTION

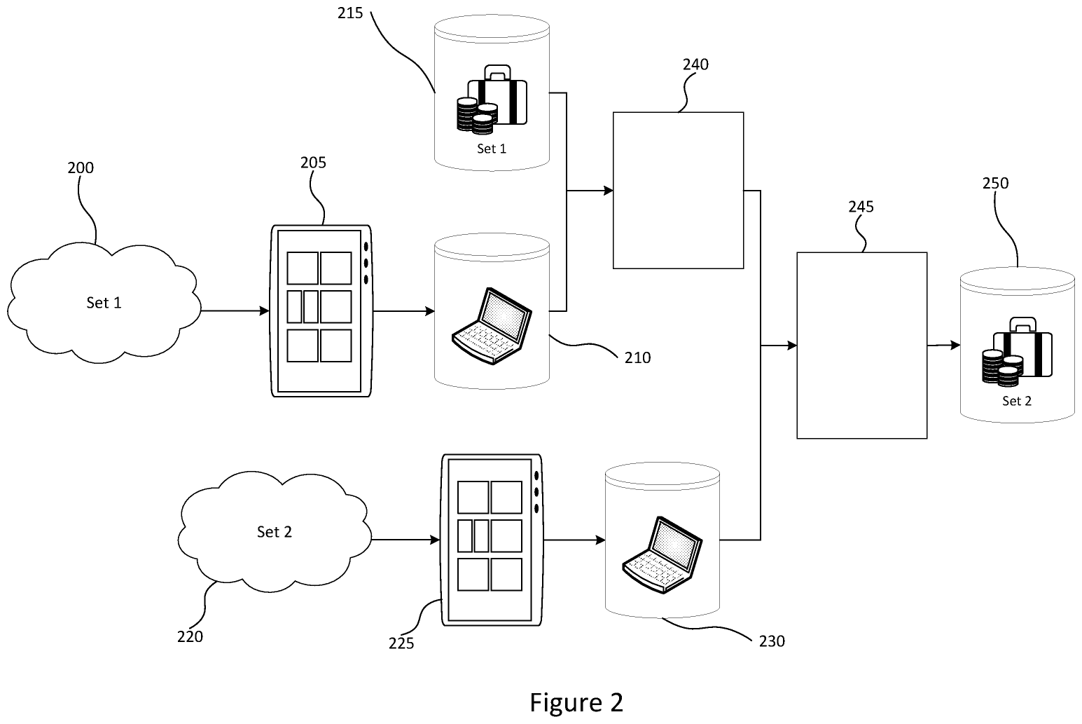

FIG. 2 shows a flow chart for sales prediction analysis based on multiple sets of online text data (i.e. text-derived data) 200, 220 according to an embodiment which will now be described in more detail.

A first set of online text data 200 is received by a data processor system 205. This first set of online text data 200 may be referred to as a “raw” first set of online text data, as it has not yet been processed according to any of the methods described herein. The online text data can be obtained from any or any combination of: one or more social media platforms, news articles, blog posts, online forum posts and review articles. The data 200 in this embodiment is text data, but in other embodiments other data types can be processed—for example audio data can be converted into text using speech-to-text conversion and video data can be similarly converted into text from both the audio layer of data in the video as well as text recognition of the visual content and/or subtitles in the visual layer of the video. The raw online text data 200 may be pre-processed in some way, but may also be provided directly from the source (for example via an API or in a database/data storage arrangement that can be queried, processed or edited as necessary) in one or more standard formats.

In a simplified embodiment, the text data 200 can comprise millions of individual documents (for example tweets or long articles, published on the world wide web). The text in these documents is processed to tag it with for example taxonomy terms for the products, ingredients, and other topics of interest. Text data containing specific combinations of terms are then eliminated from the dataset as this text data is deemed irrelevant to the topic/terms of interest. Text which mentions the topic/terms of interest is then aggregated into counts over time, producing numerical data, which can be used for training and predicting in the models employed in aspects/embodiments. Processing the raw text data as described allows the specific data of interest, or that is deemed relevant, to be used to train models and for models to predict/estimate based on this training. The definitions used to determine relevance/that text is of interest, can be manipulated by adjusting the terms/topics used when filtering the text data.

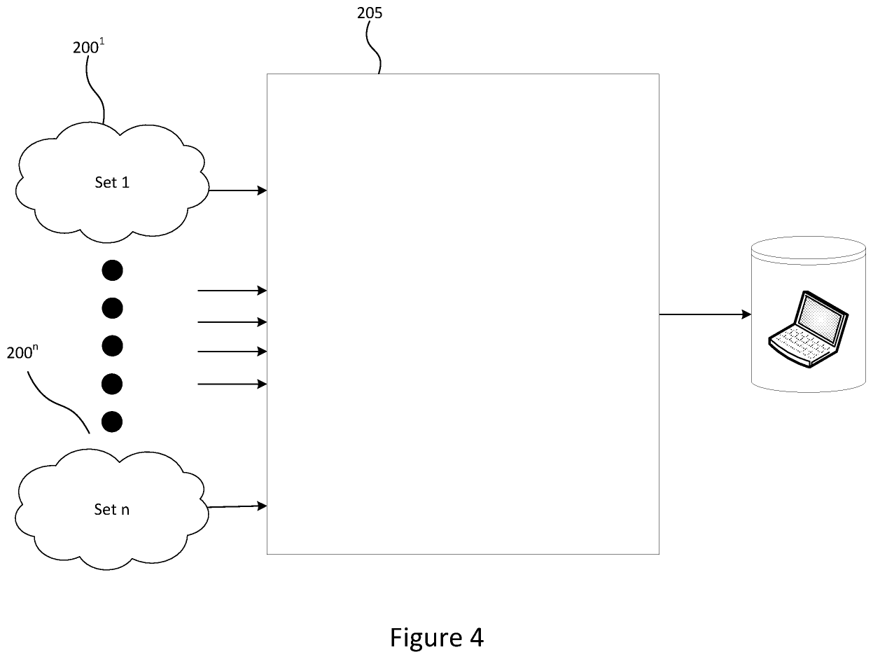

The raw first set of online text data 200 is input to a data processor 205. The data processor 205 arranges and/or reformats the raw first set of online text data 200 to output a processed first set of online text data 210. Specifically, the data processor 205 identifies properties of each post in the online text content and applies one or more tags to each post depending on the identified content within each post. Optionally, as shown in FIG. 4, the data can be augmented/improved as part of the processing of the raw online text data.

In order to combine and/or correlate text and numeric data, in this embodiment the text data must first be effectively cleaned to remove spurious text documents that contain ambiguous references that would distort the predictive value of the text data. To do this, in this embodiment, a data curation and annotation tool (also known as the “DCAT”) is used to provide human users with an interactive system for the efficient evaluation and cleaning of text from both short-form text (e.g. tweets) and long-form text (e.g. discussion forums including Reddit).

Broadly, the data curation and annotation tool combines several different data science algorithms in a pipeline which first vectorises, then reduces social data into a simple interactive two-dimensional visual format. A human user is then able to use this interactive format to quickly evaluate the noise level within whole data sets and then take actions which include either direct removal of items or portions of data and/or the creation of annotations which serve as training data to feed into a downstream models.

For example, the text data 200 may contain discussions about “red bull” for which we only want to isolate instances where a consumer is talking about their opinions of the Red Bull® energy drink, not the Red Bull®-sponsored Formula 1 racing cars, nor a sports team called the “red bulls”, nor response to a Red Bull® promotion of a music artist.

In another example, certain products are sold on the basis of a perceived health claim (e.g. “lose weight”). By tagging a manufacturer's product description to identify these claims, and then linking these descriptions/tags back to sales figures, the total sales of products with a given health claim (i.e. the example “lose weight” given above) can be determined. Consumer mentions of “lose weight” can also be identified in online conversations in the text data 200 and these can be mapped to the growth or decline in sales of the products associated with that health claim.

To process text data with sufficient accuracy (i.e. substantially not including spurious references in the output data set) and efficiency (i.e. not requiring a human to search through thousands of rows of data) the data curation and annotation tool must overcome various technical problems. If the algorithmic output is not accurate enough, the resulting training data for a model will be poor. Conversely, if the algorithm takes too long to run, it only allows a human to process a small amount of text in an a given time period.

In this embodiment the data curation and annotation tool combines five different state-of-the-art algorithms within new methods and an overall apparatus that allows a human to interact with a machine to produce the balanced output. To begin, the GloVe (Global Vectors for Word Representation) technique is used in DCAT to calculate document embeddings calculated for each social data message. The GloVe technique is implemented in a model for distributed word representation and more details can be found in the paper “GloVe: Global Vectors for Word Representation” by Jeffrey Pennington, Richard Socher, and Christopher D. Manning published in the Proceedings of the 2014 Conference on Empirical Methods in Natural Language Processing (EMNLP), pages 1532-1543, Oct. 25-29, 2014, Doha, Qatar which is hereby incorporated by reference. The model used in this embodiment is an unsupervised learning algorithm for obtaining vector representations for words. In this embodiment, this is achieved by mapping words into a meaningful space where the distance between words is related to semantic similarity. In this embodiment, the result of this initial step is a large set of 100-dimension vectors, each vector of which represents a single social data point.

Next, in order to create a human-readable visualisation these 100-dimension vectors are compressed down to two dimensions in a process which combines two different dimensional reduction algorithms. First, a technique termed principal component analysis, or “PCA”, is applied to reduce the dimensionality of the vectors from 100 dimensions down to 25 dimensions. Second, a technique termed t-distributed stochastic neighbour embedding, or “tSNE”, is applied to further reduce the dimensionality from 25 dimensions to the required two dimensions. This approach effectively overcomes the limitations inherent to each algorithm—namely that PCA is less accurate but highly performant whereas tSNE is relatively slow with a large memory footprint, while also being extremely accurate. Third, the resulting compressed two-dimensional vectors are passed through a DBSCAN algorithm (a “density-based clustering” algorithm) in order to group similar data and aid in visualisation when displaying the data to a human user to curate the data.

Finally, the resulting clustered vectors are plotted/displayed in a Graphical User Interface (GUI) which allows human curators to interrogate different sections of the dataset and curate the underlying data by deleting data and/or manually labelling data. Thanks to the preceding analysis steps, similar text data messages will end up both close together and labelled with a similar colour in the GUI. Upon selection of different subsets of the data via the visualisation users can either forward the selected data on as taxonomy terms to be fed into a downstream irrelevancy model (which is described in more detail in patent application PCT/GB2020/050960 and which is hereby incorporated by reference and which provides a score for the relevancy or irrelevancy of a document which can be used in conjunction with embodiments and/or aspects herein) or manually excluded using one of a selection of potential exclusion terms provided by a “TF-IDF” algorithm (a “term frequency-inverse document frequency” algorithm, which weighs a keyword in any content and assigns the importance of that keyword based on the number of times it appears in the document and how relevant the keyword is in a larger corpus of documents).

Optionally, in this embodiment, trends can be identified in the online text data by a count over time (determined from the timestamps on each post within the online text data) of the tags applied to each post. The processed first set of online text data 210 can then be used as part of any further analysis with respect to a first set of sales data 215.

It will be noted that the sales data 215 will be for a period of time following the period of time represented by the processed online text data 210 (e.g. the sales data might be for March of the current year whereas the online text data might be for February of the current year)

A model 240 is then used to determine a correlation between the first set of sales data 215 and the processed first set of online text data 210.

The sales data 215 contains at least some numerical values over time for one or more products, preferably including details of these sales such as the details of the products being sold and the pricing and sales data for the transactions. The sales data 215 is tagged to enable the tags in the sales data 215 to be correlated to the tags in the processed online text data 210.

Clean, relevant text data must be further manipulated and technically transformed to produce a numerical dataset such that aggregations of terms can be used to make reliable predictions.

Broadly speaking, businesses want to produce products that are “on trend” such that product supply is equal to consumer demand at a convergent point in time. Deciding to build products for which consumer demand is too nascent or is waning results in inefficient supply vs. demand volumes. Instead, businesses seek to identify trends for which consumer demand is consistently growing, such that availability of the product meets early consumer demand to create product and brand equity, whilst impeding competitor product launches.

In order to isolate which trends are in the proper maturity phase for new product development, one must produce numeric data that describe the text data in such a way as to allow for maturity phase classification.

First, in this embodiment the method counts instances of a specific trends like “red bull” in the specific context of energy drink consumption, within our clean text data over a 24-month window.

Second, the method gathers other trend counts in the energy drink category to produce a unified dataset of categorically relevant trends.

Third, the method classifies the maturity phase of each trend: “dormant” trends show stable rate of growth and low volume, “emerging” trends rising rate of growth and low volume, while “growing” trends show a rising rate of growth and high volume, “mature” trends show a stable rate of growth and high volume, “declining” trends show decreasing rate of growth and high volume, and finally “fading” trends show a decreasing rate of growth and low volume.

Fourth, we compute a Trend Prediction Value (a.k.a. “TPV”), which is real number value that ranks each trend compared to each other in a given category, taking into considerations historical growth, growth consistency, forecast growth and a volumetric weighting function.

Finally, every month we compare (“prevRelDist”) previous (dist_{previous phase}) and next (dist_{next phase}) phase classifications, such that we can visually plot in a GUI the progression of trends through phases, such that humans can understand the changes in trends, shown in the following equation:

$$prev RelDist = \frac{{dist}_{previous phase}}{{dist}_{previous phase} + {dist}_{next phase}}$$

In embodiments, the model leans how changes in the social data over time (i.e. the text-derived data) relate to changes in the sales data (i.e. the numerical data), so for example from the data it might be determined that if ingredient X is mentioned more frequently in social medial, then after Y months it will see a Z increase in its associated sales.

To return to the “red bull” example, for an example set of data the model might assign a TPV value of 369 and a phase ranking of “mature” to the Red Bull® brand, specifically as it relates only to energy drinks as our clean text data excludes the other contexts of racing, sport teams, etc that would otherwise distort the prediction of Red Bull® energy drinks. The model will also define which other related products (e.g. alcohol), benefits (e.g. boosts energy), themes (e.g. sugar-free), ingredients (e.g. taurine) represent statistically significant consumer associations with the brand.

In this embodiment, there is then performed a combination of text, predictive numeric data and (numeric) sales data. Now that the described method has transformed mentions of specific words in text to a clean dataset that includes predictive numeric values, it can further combine it with the sales data in order to predict which combinations of trends a business may seek to turn into a product. For example, the high association of Red Bull® energy drinks with alcohol presents a potential product opportunity for pre-mixed caffeinated alcohol drinks for example. Referring to FIG. 2, a specific embodiment of a method to predict future sales data using historical sales data and online text data will now be described in more detail.

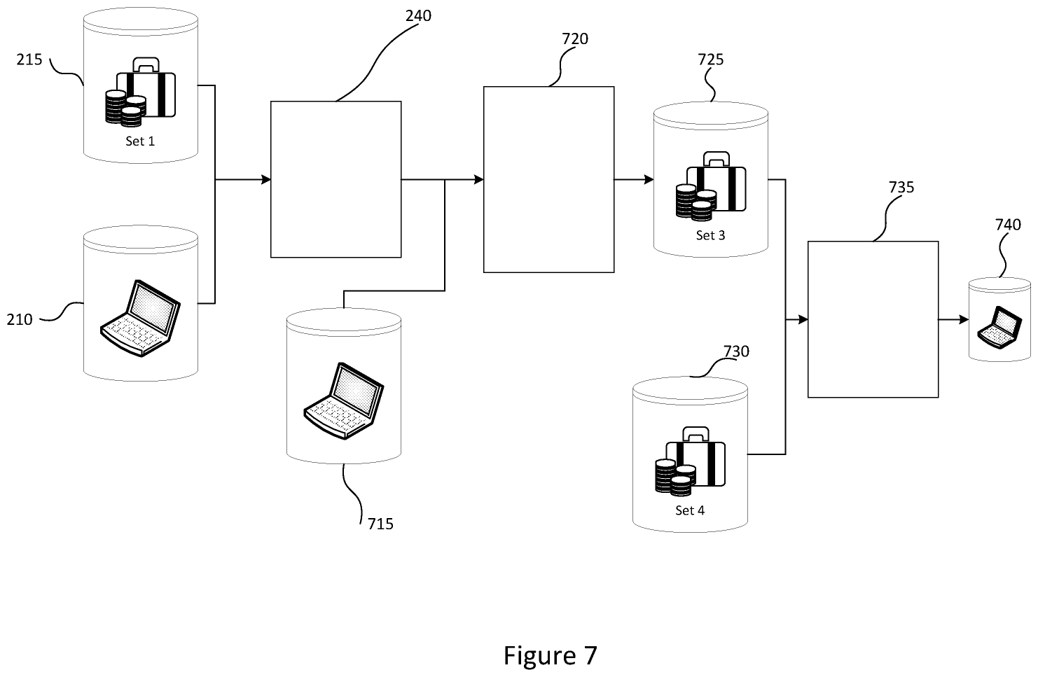

The step of determining the correlation 240 involves generating a learned model to match the trends in the online text data 210 with the sales of products represented by the sales data 215. This learned relationship is determined using multiple random forest models, using the processed online text data 210 and the sales data 215 as training datasets The models are trained using the online text data and data derived from that from the first period and the sales data 215 as the target. Further sales data can used for test and validation, as described further in respect of FIG. 7 below. The models are trained using a rolling window technique. This technique utilises the fact that X amount of time series data can be split more ways to Y1 and Y2 size where Y1+Y2<X. This technique can help build more robust models.

In an optionally parallel process, a second set of online text data 220 is collated. This second set of online text data 220 may also be referred to as a “raw” second set of online text data. In a similar method to that in respect of the raw first set of online text data 200, the raw second set of online text data 220 is input to a data processor 225. The data processor 225 arranges and/or reformats the raw second set of online text data 220 to output a processed second set of online text data 230.

Using the correlation determined between the first set of sales data 215 (from a second time window) and the processed first set of online text data 210 (from a first time window), and then applying the correlation to the processed second set of online text data 230 (from the second time window or later time window), a second set of sales data 250 (for the third time window or correspondingly later time window) is predicted. The predicted second set of sales data 250 may reflect sales data which is forecast for a different period of time, or in a new market or territory, and may be a useful tool when assessing future investments for a business or simply to enable more accurate business planning.

The correlation is captured in one or more models that are trained on both the sales data 215 and the processed first set of online text data 210. The model(s) can be a set of decision trees which represent learned correlations between given variables (in each set of data). The combination of correlations can then be used to make predictions, given just the variables in one of the sets of data, of the other set of data. As an example, in the “red bull” example above, the Red Bull® energy drink contains both taurine and caffeine.

It will be noted that the predicted sales data 250 will be for a future period of time (following the examples given above, the online text data used to predict the future sales might be for March of the current year and the predicted sales data might be for April of the current year).

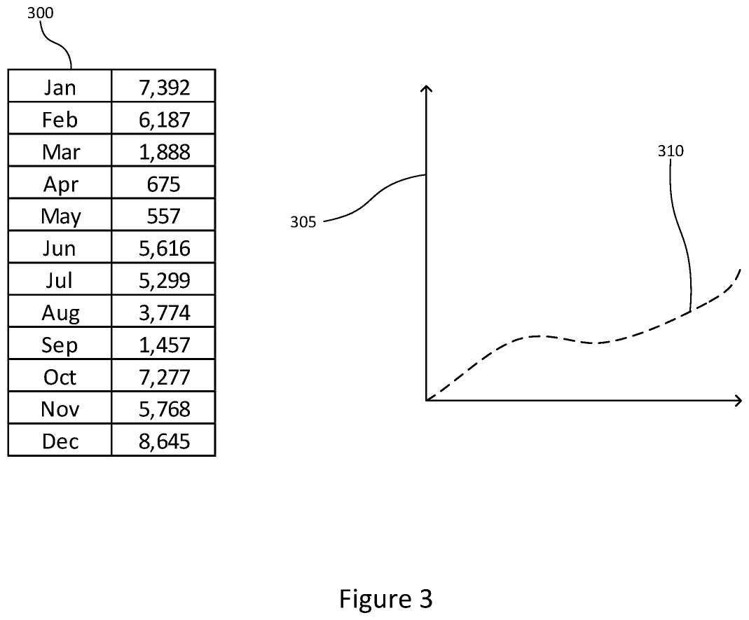

Referring to FIG. 3, the outputs of the specific embodiment in FIG. 2, specifically the predicted second set of sales data 250, are shown in two distinct exemplary formats. The first format is a discrete forecast 300. This discrete forecast 300 represents a predicted second set of sales data 250 according to a number of separate blocs, in this example according to the months of the year. The second format represents a more continuous forecast 305, with a dashed line 310 representing predicted sales over a predetermined time period. The sales data combined with the TPV data implicitly identifies which categories are for example “emerging” or “growing”, which can correlate with the target desire of a product manufacturer to produce a new product to meet peak consumer demand.

Referring to FIG. 4, more detail about how one or more social datasets are created and enriched will now be described.

A very large amount of data may be extracted from an online text platform, but its usefulness in terms of prediction analysis may be limited. Therefore, one or more sets of extracted raw online text data 200¹-200ⁿ can be processed into a form more amenable to analysis.

This processing takes place within a data processor 205, and an output is generated in the form of one or more processed sets of online text data. Specifically, further data is acquired in order to more accurately apply tags (or labels or metadata) to each of the posts in the online text data.

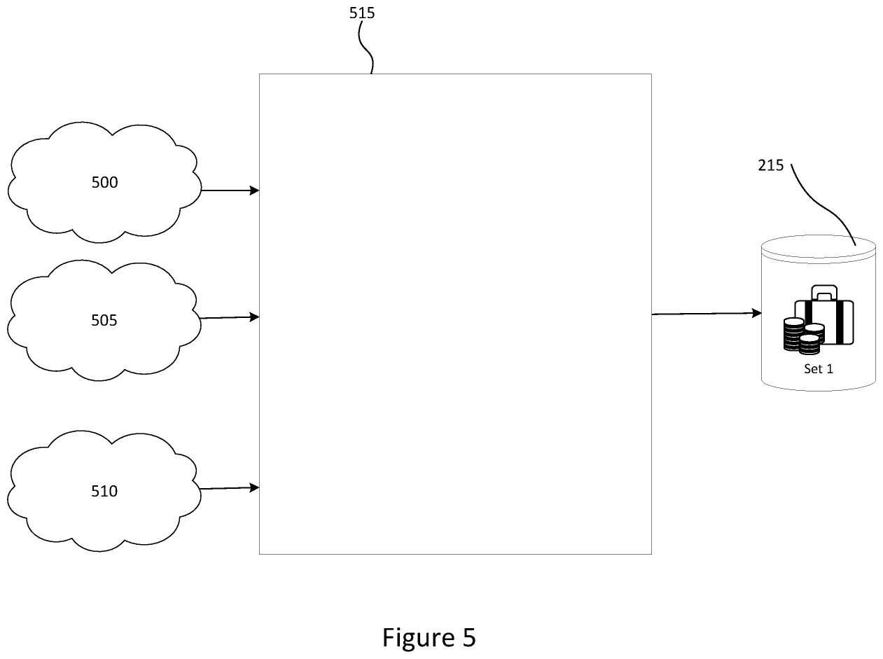

Referring to FIG. 5, more detail about how the sales dataset(s) are created and/or augmented will now be described.

The raw sales data 500 will typically include details about each line of products sold, where each product has a unique identified such as a stock number or a bar code. Each of the products may be similarly branded to one or more other products but may be different flavours, packet sizes, packaging formats, unit sizes, differently sub-branded, in different languages, etc. Some of this information is relevant and some of it is irrelevant. Tagging can be applied to each product that is uniquely identified in order to be able to group together products having the same brand, products having common ingredients, etc.

Further data that is otherwise absent from the raw sales data 500, or which can't be derived from the raw sales data 500, can be obtained from other data sources such as data 505 and other databases 510.

For example, data 505 might include marketing information related to one or more of the products or services represented in the raw sales data 500. For example, there may be no ingredients list for each product in the raw sales data 500 but this would enable the identification of products having certain ingredients of interest. By obtaining data about the products and services represented by the raw sales data 500 from publicly available websites, the sales enrichment process 515 (which is typically implemented on a processing means such as a server system or computer) can augment the raw sales data 500 with derived information from the sales data 500 and with further information about the products represented in the raw sales data 500 that is obtained and augmented with the raw sales data 500 from the data 505.

Other data sources 510 might include manufacturer datasets, regulator data, supplier data, logistics data, distributor data, retailer data or market information data/polling data/customer survey data. This might include further data that can be used to enrich the sales data 215.

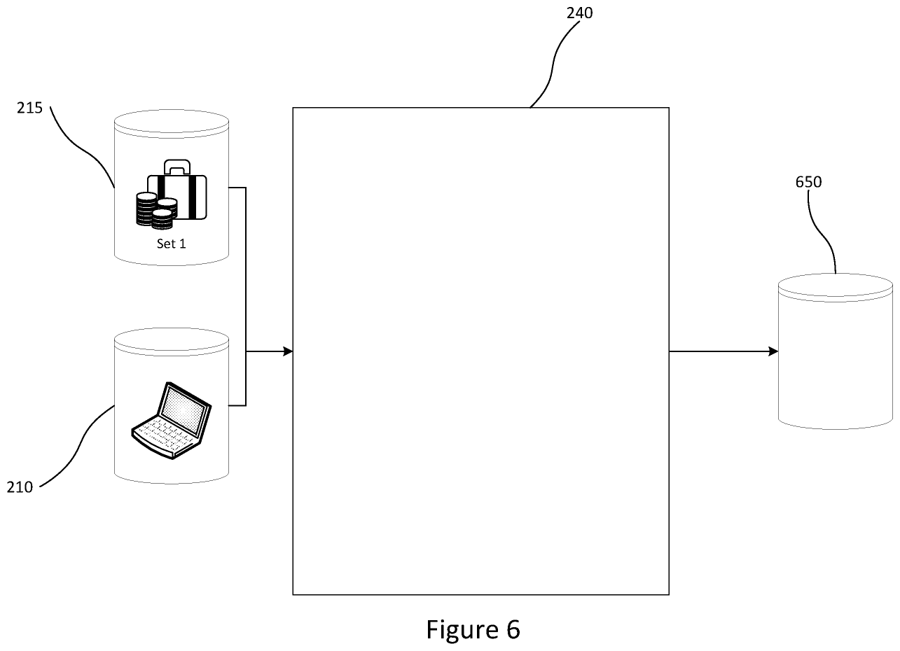

Referring to FIG. 6, more detail about how the model and/or correlation is determined will now be described.

The correlation process in this embodiment uses multiple random forest models trained on the sales data 215 and the processed online text data 210. The models are trained to predict different time windows, meaning that if the target period to which the prediction is set is to 18 months, then 18 models are trained, one for each time window. Optionally, rolling training windows can be used, whereby the time period of the training window is iteratively adjusted forwards or backwards but still constrained a set length of time between start and end times.

Referring to FIG. 7, an embodiment describing how the determined correlation and/or model can be tested and/or refined will now be described.

As described above, the sales data 215 and processed online text data 210 are used to determine one or more correlations between the tagged information within each dataset, to determine a relationship between the trend data within the online text dataset for a prior period of time and each product and common tags across products within the sales dataset for a later period of time. Using this determined correlation, in the form of a trained model, predictions for future sales can be made for a future period of time (after both the prior and later periods of time). The tagging allows matching between social data/text/text-derived data and sales data/numerical data.

To test that the correlation model that has been generated is suitably accurate, historical data that hasn't been used for training can be used to validate the accuracy of the model 240 that has been generated.

Using another set of processed test online text data 715, and the model 240 representing the correlation between the sales and social data, a prediction for future sales 725 based on the processed test online text data 715 can be generated. As the sales for the period that has just been predicted is known 730, the predicted sales for the period 725 can be compared to this actual sales data 730 and an accuracy metric determined. Accuracy metrics can include median absolute percentage error for sales predictions and/or mean absolute percentage error for brand and/or product count predictions.

The accuracy metrics can be used to assess whether to use the model previously generated for prediction purposes, or can be used to improve the model by refining it using either the accuracy metric itself, or by adapting or rebuilding the model using more or different combinations of training data.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

What is claimed is:

1. A computer-implemented method of generating a third set of numerical data using a second set of numerical data and a first and a second set of text derived data, comprising the following steps:
receiving the second set of numerical data, the second set of numerical data comprising numerical data in a second time period;
receiving the first set of text derived data, wherein the first set of text derived data comprises derived data from text data in a first time period and one or more labels;
determining numerical values of the labels in the first set of text derived data;
determining a correlation between the second set of numerical data and the first set of text derived data using the determined numerical values of the labels in the first set of text derived data;
receiving the second set of text derived data, wherein the second set of text derived data comprises derived data from text data in the second time period and one or more labels;
determining numerical values of the labels in the second set of text derived data;
using the second set of text derived data, the determined numerical values of the labels in the second set of text derived data and the determined correlation between the second set of numerical data and the first set of text derived data to generate the third set of numerical data wherein the third set of numerical data comprises generated numerical data in a third time period; and
generating an output based at least in part on the third set of numerical data
wherein, the first time period, the second time period and the third time period correspond to different time periods.

2. The method of claim 1, wherein the second set of numerical data comprises quantitative data based on historical numerical data, optionally wherein the second set of numerical data further comprises metadata, wherein the metadata comprises any or any combination of: sale time and date information, sale location information; product details, unique product codes, unique product types, product description, ingredients data, product branding information, product sub-branding information, product category; pricing data, volume data, unit sales, theme information and average price data.

3. (canceled)

4. The method of claim 1 further comprising a step of curating the second set of numerical data wherein the second set of numerical data is generated from a combination of quantitative data based on historical numerical data and additional product information data, optionally wherein the additional product information data is obtained by extracting relevant product information data from one or more data sources.

5. (canceled)

6. (canceled)

7. (canceled)

8. The method of claim 1 wherein the labels of the first set of text derived data comprise one or more trends and/or themes.

9. (canceled)

10. (canceled)

11. The method of claim 1 wherein the first set of text derived data further comprises any or any combination of: an online conversation volume; an online conversation growth; an online conversation split by data source and trend prediction value; and data generated from a plurality of online text data, optionally wherein the plurality of online text data comprises social media data.

12. The method of claim 1 further comprising a step of matching the second set of numerical data and the first set of text derived data.

13. (canceled)

14. The method of claim 1 wherein determining the correlation between the second set of numerical data and the first set of text derived data comprises:
determining one or more common labels and/or metadata in each of the second set of numerical data and the first set of text derived data; and determining the correlation between the one or more common labels and/or metadata, optionally wherein the one or more common labels and/or metadata comprise any or any combination of: one or more taxonomy categories; brand, product type, ingredients, and claims; and/or
determining a learned relationship between the second set of numerical data and the first set of text derived data, optionally wherein the learned relationship comprises using any or any combination of: one or more random forest models or methods; grid search techniques; rolling train techniques; rolling window techniques; and test window techniques.

15. (canceled)

16. (canceled)

17. (canceled)

18. The method of claim 1 wherein the step of determining the correlation between the second set of numerical data and the first set of text derived data comprises determining one or more trends in the text derived data and then determining a relationship between each of the one or more trends to one or more products in the second set of numerical data.

19. The method of as in claim 1 further comprising a step of testing the correlation determined between the second set of numerical data and the first set of text derived data, the step of testing comprising:
receiving a third set of text derived data, wherein the third set of text derived data comprises derived data from text data in the third time period;
using the third set of text derived data and the determined correlation between the second set of numerical data and the first set of text derived data, generating the testing set of numerical data wherein the testing set of numerical data comprises generated numerical data in a fourth time period;
receiving a fourth set of numerical data, the fourth set of numerical data comprising sales data in the fourth time period;
determining an accuracy metric of the determined correlation, the step of determining an accuracy metric comprising comparing the testing set of numerical data with the fourth set of numerical data; and
generating an output based at least in part on the accuracy metric.

20. The method of claim 9 further comprising the step of determining an improved correlation; the step of determining an improved correlation comprising determining a correlation of any two of: (a) the second set of numerical data and the first set of text derived data; (b) the fourth set of numerical data and the third set of text derived data; (c) the testing set of numerical data and the third set of text derived data; (d) the testing set of numerical data and the fourth set of numerical data; (e) the determined accuracy metric.

21. (canceled)

22. (canceled)

23. (canceled)

24. The method of claim 1 wherein the output generated comprises any or any combination of: instructions to increase, decrease or repurpose production facilities or capacity; configuration data for production machinery; usage plans for one or more plant or machinery; instructions to increase orders of raw materials or other supplies; instructions to place increased or decreased advertising, optionally sending said instructions directly to one or more advertising servers; instructions to amend or amendments to stock availability data or forecast data, optionally sending these to one or more purchaser servers; instructions to amend or amendments to raw materials or components ordering data or ordering forecast data, optionally sending these to one or more supplier servers.

25. (canceled)

26. A method of data curation, for curating and/or cleaning text-derived data to isolate the text-derived data relating to one or more topics of interest, comprising:
receiving text-derived data and information indicating one or more topics of interest;
determining a set of vector representations of the text-derived data in a first set of dimensions, wherein each dimension represents one topic;
determining a second set of vector representations of the text-derived data in a second reduced set of dimensions using a first dimension reduction algorithm;
determining a third set of vector representations of the text-derived data in two dimensions using a second dimension reduction algorithm;
grouping similar data in the third set of vector representations using a density-based clustering algorithm to produce an output set of data;
displaying the output set of data to a user for curation, wherein displaying the output set of data comprising displaying the output set of data using a two-dimensional graphical user interface.

27. The method of claim 26 wherein determining a set of vector representations of the text-derived data in a first set of dimensions comprises using global vectors for word representation algorithm and wherein the first set of dimensions comprises substantially one thousand dimensions.

28. The method of claim 26 wherein the first dimension reduction algorithm comprises a principal component analysis algorithm; and the second reduced set of dimensions comprises substantially twenty five dimensions; and the second dimension reduction algorithm comprises a t-distributed stochastic neighbour embedding algorithm.

29. The method of any of claim 26 wherein the density-based clustering algorithm comprises DBSCAN.

30. The method of claim 26 wherein displaying the output set of data to a user for curation comprises using a TF-IDF algorithm.

31. The method of claim 26 further comprising receiving user input to perform any of: deleting one or more data from the text-derived data; and/or tagging, labelling or applying metadata to the text-derived data using the graphical user interface.

32. A method of determining a trend prediction value comprising the steps of:
determining one of more topics of interest;
receiving text-derived data and determining a plurality of topics within the text-derived data, wherein the plurality of topics comprise the one or more topics of interest and other topics;
determining a plurality of numerical values for the number of times each of the plurality of topics are mentioned in the text-derived data;
determining a relative value of the numerical values of the one or more topics of interest versus the numerical values of the other topics in the text-derived data; and
outputting the relative value.

33. The method of claim 32 wherein the numerical values are determined for a pre-determined time period, optionally wherein the pre-determined time period is adjusted by user input or comprises a 24-month period of time.

34. The method of claim 32 wherein outputting the relative value further comprises determining a trend value and outputting the trend value; optionally wherein the trend value comprises any or any combination of: dormant; emerging; growing; mature; declining; or fading.
